(19) United States
(12) Patent Application Publication
(10) Pub. No.: US 2025/0202048 A1
(43) Pub. Date: Jun. 19, 2025

(54) SEPARATOR FOR ELECTROCHEMICAL DEVICE, MATERIAL AND ELECTROCHEMICAL DEVICE

(71) Applicant: Sumitomo Chemical Company, Limited, Tokyo (JP)

(72) Inventors: Koki SUWA, Niihama-shi (JP); Makoto FURUKAWA, Niihama-shi (JP)

(21) Appl. No.: 18/976,577

(22) Filed: Dec. 11, 2024

(30) Foreign Application Priority Data
Dec. 13, 2023 (JP) 2023-210498
Jun. 13, 2024 (JP) 2024-096196

(51) Int. Cl. H01M 50/423; H01G 11/52; H01M 50/417; H01M 50/446; H01M 50/451; H01M 50/46; H01M 50/489

(52) U.S. Cl. CPC H01M 50/423; H01G 11/52; H01M 50/417; H01M 50/446; H01M 50/451; H01M 50/461; H01M 50/489

(57) ABSTRACT

Provided is a separator for an electrochemical device which separator achieves both high ion permeability and a low moisture content. The separator of the present disclosure includes a porous layer that contains two or more nitrogen-containing aromatic resins and that has a filler content of not less than 0% by weight and less than 20% by weight.

This Nonprovisional application claims priority under 35 U.S.C. § 119 on Patent Application No. 2023-210498 filed in Japan on Dec. 13, 2023 and Patent Application No. 2024-096196 filed in Japan on Jun. 13, 2024, the entire contents of which are hereby incorporated by reference.

### TECHNICAL FIELD

The present invention relates to a separator for an electrochemical device (hereinafter referred to as a “separator”), a material for an electrochemical device (hereinafter referred to as a “material”), and an electrochemical device.

### BACKGROUND ART

Electrochemical devices, e.g., nonaqueous electrolyte secondary batteries, particularly lithium ion secondary batteries, have a high energy density, and are therefore widely used as batteries for personal computers, mobile telephones, portable information terminals, cars, and the like.

As a material of such a nonaqueous electrolyte secondary battery, a separator having excellent heat resistance is under development. For example, as in Patent Literature 1, a separator is known in which a heat-resistant layer containing an aramid resin and inorganic particles is formed on a porous substrate.

### CITATION LIST

### Patent Literature

### [Patent Literature 1]

International Publication No. WO 2019/176421

### SUMMARY OF INVENTION

### Technical Problem

Inorganic particles (filler) as disclosed in Patent Literature 1 can be used as an open-pore material for ensuring ion permeability by making a heat-resistant layer porous. However, such a conventional technique as described above has room for improvement in order to reduce the amount of moisture mixed in a heat-resistant layer. In order to prevent or reduce, for example, gas generation in a battery, it is preferable to reduce the amount of moisture mixed in a heat-resistant layer.

An aspect of the present invention has an object to provide a separator that achieves both high ion permeability and a low moisture content.

### Solution to Problem

The inventors of the present invention conducted diligent studies in order to attain the object, and consequently found that a separator which achieves both high ion permeability and a low moisture content can be provided by using two or more nitrogen-containing aromatic resins and controlling a filler content to not less than 0% by weight and less than 20% by weight.

A separator in accordance with an aspect of the present invention includes a porous layer that contains two or more nitrogen-containing aromatic resins and that has a filler content of not less than 0% by weight and less than 20% by weight.

### Advantageous Effects of Invention

An aspect of the present invention makes it possible to provide a separator that achieves both high ion permeability and a low moisture content.

### DESCRIPTION OF EMBODIMENTS

The following description will discuss embodiments of the present invention. Note, however, that the present invention is not limited to the embodiments. Any numerical range expressed as “A to B” herein means “not less than A and not more than B” unless otherwise stated.

### [1. Separator]

A separator in accordance with an embodiment of the present invention includes a porous layer that contains two or more nitrogen-containing aromatic resins and that has a filler content of not less than 0% by weight and less than 20% by weight.

A filler can be used to ensure ion permeability by making a porous layer porous. Without using a filler, it is difficult to form open pores. This tends to increase air permeability and reduce ion permeability. However, using a large amount of filler, e.g., alumina filler tends to also increase the amount of moisture mixed in a porous layer. Further, using a large amount of alumina filler also results in an increase in cost.

In view of the above, the inventors of the present invention conducted diligent studies and found the following: even without using a filler or even in a case where a filler content is reduced as compared with a conventional filler content, using two or more nitrogen-containing aromatic resins makes it possible to achieve high ion permeability. The following mechanism can be considered, though speculative. Assume that two or more nitrogen-containing aromatic resins differ in ease of dissolution (deposition property). In this case, in the process of deposition, a resin (first resin) that is not easily dissolved is deposited earlier, whereas a resin (second resin) that is easily dissolved is deposited later. Due to compatibility between the first resin and a solvent, the second resin is deposited near the first resin that has been deposited earlier. It is considered that the resins thus deposited so as to be unevenly distributed allow open pores to be sufficiently formed even without using a filler or even in a case where a filler content is reduced as compared with a conventional filler content.

In an embodiment of the present invention, as a material included in an electrochemical device, the porous layer can be provided between a polyolefin porous substrate and at least one of a positive electrode and a negative electrode. Hereinafter, the polyolefin porous substrate is also referred to simply as a “porous substrate”. The porous layer may be provided between the porous substrate and at least one of the positive electrode and the negative electrode in a manner so as to be in contact with the porous substrate and the at least one of the positive electrode and the negative electrode. The number of porous layer(s) provided between the porous substrate and at least one of the positive electrode and the negative electrode may be one, two, or more. The porous layer is preferably an insulating layer.

A nitrogen-containing aromatic resin means an aromatic resin containing a nitrogen atom. An aromatic resin means a resin containing a structural unit having at least an aromatic group.

Examples of the nitrogen-containing aromatic resin include aromatic polyamides such as a wholly aromatic polyamide (aramid resin) and a semi-aromatic polyamide, aromatic polyimides, aromatic polyamide imides, polybenzimidazoles, aromatic polyurethanes, and melamine resins. In particular, the nitrogen-containing aromatic resin preferably includes an aramid resin.

Examples of the aramid resin include para-aramids and meta-aramids. Among these, para-aramids are more preferable. Examples of the para-aramids include para-aramids each having a para-oriented structure or a quasi-para-oriented structure, such as poly(paraphenylene terephthalamide), poly(parabenzamide), poly(4,4′-benzanilide terephthalamide), poly(paraphenylene-4,4′-biphenylene dicarboxylic acid amide), poly(paraphenylene-2,6-naphthalene dicarboxylic acid amide), poly(2-chloro-paraphenylene terephthalamide), a paraphenylene terephthalamide/2,6-dichloroparaphenylene terephthalamide copolymer, poly(4,4′-diphenylsulfonyl terephthalamide), and a paraphenylene terephthalamide/4,4′-diphenylsulfonyl terephthalamide copolymer. Examples of the meta-aramids include poly(metaphenylene terephthalamide), poly(metaphenylene isophthalamide), poly(metabenzamide), poly(metaphenylene-4,4′-biphenylene dicarboxylic acid amide), and poly(metaphenylene-2,6-naphthalene dicarboxylic acid amide). Poly(metaphenylene isophthalamide) is also referred to as poly[N,N′-(1,3-phenylene) isophthalamide].

The two or more nitrogen-containing aromatic resins preferably include resins having different deposition properties as described earlier. It is preferable to combine resins having different structures, such as a resin having a rigid structure and a resin having flexibility. For example, poly(paraphenylene terephthalamide), poly(2-chloro-paraphenylene terephthalamide), poly(parabenzamide), and poly(4,4′-benzanilide terephthalamide) have a rigid structure. In contrast, poly(4,4′-diphenylsulfonyl terephthalamide), a paraphenylene terephthalamide/4,4′-diphenylsulfonyl terephthalamide copolymer, and a meta-aramid have flexibility. Note, however, that a combination of the two or more nitrogen-containing aromatic resins is not limited to these combinations. Even in a case where resins having relatively close structures are combined as in, for example, a combination of poly(paraphenylene terephthalamide) and poly(2-chloro-paraphenylene terephthalamide) which combination is shown in Examples, sufficient ion permeability can be achieved, and ion permeability can further be improved by adjusting a filler content as appropriate. The two or more nitrogen-containing aromatic resins are preferably contained in a single-layer porous layer.

In a case where the porous layer contains a first nitrogen-containing aromatic resin and a second nitrogen-containing aromatic resin, a weight ratio between the first nitrogen-containing aromatic resin and the second nitrogen-containing aromatic resin is preferably 5:95 to 95:5, and more preferably 10:90 to 90:10 from the viewpoint of ion permeability.

A proportion of a nitrogen-containing aromatic resin in 100% by weight of a resin contained in the porous layer is preferably more than 50% by weight, more preferably not less than 70% by weight, and still more preferably not less than 90% by weight. The proportion of the nitrogen-containing aromatic resin in 100% by weight of the resin contained in the porous layer may be not more than 100% by weight, or may be less than 100% by weight. The resin contained in the porous layer particularly preferably consists only of a nitrogen-containing aromatic resin.

The porous layer may contain a nitrogen-containing aromatic resin and a resin other than the nitrogen-containing aromatic resin. A proportion of the resin other than the nitrogen-containing aromatic resin in 100% by weight of the resin contained in the porous layer is preferably less than 50% by weight, more preferably not more than 30% by weight, and still more preferably not more than 10% by weight. The proportion of the resin other than the nitrogen-containing aromatic resin in 100% by weight of the resin contained in the porous layer may be not less than 0% by weight, or may be more than 0% by weight.

Examples of the resin other than the nitrogen-containing aromatic resin include polyolefin-based resins; (meth)acrylate-based resins; fluorine-containing resins; polyester-based resins; rubbers; resins each having a melting point or a glass transition temperature of not lower than 180° C.; water-soluble polymers; polycarbonates; and polyacetals. In an embodiment, the resin contained in the porous layer can be a resin that is not a polyester-based resin. For example, in a case where a mixture is employed that is obtained by mixing, with a nitrogen-containing aromatic resin having excellent heat resistance, an adhesive (meth)acrylate-based resin and/or an adhesive fluorine-containing resin as a resin(s) other than the nitrogen-containing aromatic resin, it is possible to obtain a porous layer that achieves both heat resistance and adhesiveness. In this case, the (meth)acrylate-based resin and/or the fluorine-containing resin is/are present in any form that is not particularly limited, and may be in particle form, may be present in a state of being mixed with the nitrogen-containing aromatic resin, or may be segregated on a surface of the porous layer.

Examples of the polyester-based resins include aromatic polyesters such as a polyarylate and liquid crystal polyesters.

Examples of the rubbers include a styrene-butadiene copolymer and a hydride thereof, a methacrylic acid ester copolymer, an acrylonitrile-acrylic acid ester copolymer, a styrene-acrylic acid ester copolymer, ethylene propylene rubber, and polyvinyl acetate.

Examples of the fluorine-containing resins include polyvinylidene fluoride (PVdF), polytetrafluoroethylene, a vinylidene fluoride-hexafluoropropylene copolymer, a tetrafluoroethylene-hexafluoropropylene copolymer, a tetrafluoroethylene-perfluoroalkylvinyl ether copolymer, a vinylidene fluoride-tetrafluoroethylene copolymer, a vinylidene fluoride-trifluoroethylene copolymer, a vinylidene fluoride-trichloroethylene copolymer, a vinylidene fluoride-vinyl fluoride copolymer, a vinylidene fluoride-hexafluoropropylene-tetrafluoroethylene copolymer, and an ethylene-tetrafluoroethylene copolymer. Particular examples of the fluorine-containing resins include fluorine-containing rubber having a glass transition temperature of not higher than 23° C.

Examples of the resins each having a melting point or a glass transition temperature of not lower than 180° C. include polyphenylene ether, polysulfone, polyether sulfone, polyphenylene sulfide, polyetherimide, polyamide imide, polyether amide, and polyether ether ketone.

Examples of the water-soluble polymers include polyvinyl alcohol, polyethylene glycol, cellulose ether, sodium alginate, polyacrylic acid, polyacrylamide, and polymethacrylic acid.

The porous layer can be a heat-resistant layer. The heat-resistant layer means a layer having a higher melting temperature than a substrate. The resin contained in the porous layer can be a resin having heat resistance. The resin having heat resistance can be a resin having a higher melting point or glass transition temperature than a resin constituting the substrate. The resin contained in the porous layer is preferably a resin that is insoluble in an electrolyte of the electrochemical device and that is electrochemically stable when the electrochemical device is in normal use.

The filler can be an inorganic filler or an organic filler. The filler is preferably a filler made of an inorganic oxide such as silica, calcium oxide, magnesium oxide, magnesium hydroxide, barium sulfate, titanium oxide, alumina, mica, zeolite, aluminum hydroxide, or boehmite, more preferably a filler made of calcium oxide, magnesium oxide, magnesium hydroxide, barium sulfate, alumina, or boehmite, and still more preferably a filler made of alumina.

Examples of the organic filler include fillers made of (i) a homopolymer of a monomer such as styrene, vinyl ketone, acrylonitrile, methyl methacrylate, ethyl methacrylate, glycidyl methacrylate, glycidyl acrylate, or methyl acrylate, or (ii) a copolymer of two or more of such monomers; a fluorine-based resin such as polytetrafluoroethylene, a tetrafluoroethylene-hexafluoropropylene copolymer, a tetrafluoroethylene-ethylene copolymer, or polyvinylidene fluoride; a melamine resin; an urea resin; polyolefin; or polymethacrylate. These organic fillers each can be used solely, or a mixture of two or more thereof can be alternatively used. Among these organic fillers, polytetrafluoroethylene powder is preferable due to its chemical stability. Alternatively, the organic filler may be polyolefin in order to improve a shutdown property of a separator. In a case where polyolefin is used as the organic filler, it is possible to impart a shutdown property to the porous layer.

A filler content in 100% by weight of the porous layer is not less than 0% by weight and less than 20% by weight, may be 0% by weight to 15% by weight, may be 0% by weight to 10% by weight, or may be 0% by weight to 5% by weight. A filler content of 0% by weight means that the porous layer does not contain the filler. In order to ensure ion permeability, the filler content in 100% by weight of the porous layer may be more than 0% by weight, or may be not less than 1% by weight.

The filler has an average particle diameter of preferably 0.01 m to 1 μm, more preferably 0.01 μm to 0.8 μm, still more preferably 0.01 m to 0.5 μm, even more preferably 0.01 μm to 0.1 μm, and particularly preferably 0.01 μm to 0.05 μm. The filler having an average particle diameter of not less than 0.01 μm easily causes pores in the porous layer to have a larger pore diameter. This makes it difficult for ion permeability to decrease even in a case where a separator is compressed in a battery. Further, since unevenness is easily formed on the surface of the porous layer, the separator can have an improved antistatic property and improved slidability. Meanwhile, the filler having an average particle diameter of not more than 1 μm allows the separator to have improved heat resistance and to be thinner. In order to achieve both these properties, it is possible to use, in combination, fillers having different average particle diameters, or to use a filler having a wide particle size distribution. The average particle diameter of the filler has a lower limit that is not particularly limited and may be, for example, 0.005 μm.

Note here that the average particle diameter of the filler is an average value of sphere equivalent particle diameters of 50 particles of the filler. Further, the sphere equivalent particle diameters of the filler are values obtained by actual measurement with use of a transmission electron microscope. The following is a specific example of a measurement method.

1. An image of the filler is captured by using a transmission electron microscope (TEM; JEOL Ltd., transmission electron microscope JEM-2100F) at an acceleration voltage of 200 kV and at a magnification ratio of 10,000 times with use of a Gatan Imaging Filter.
2. In the image thus obtained, an outline of a particle is traced by using image analysis software (ImageJ) and a sphere equivalent particle diameter of a filler particle (primary particle) is measured.
3. The above measurement is carried out for 50 filler particles that have been randomly extracted. An arithmetic average of sphere equivalent particle diameters of the 50 filler particles is regarded as the average particle diameter of the filler.

The porous layer may contain another component different from the nitrogen-containing aromatic resin and the filler, provided that the object of the present invention is prevented from being attained. For example, the porous layer may contain, as the another component, an additive that is commonly used in a separator. The another component may be one type of component, or may be a mixture of two or more types of components.

Examples of the additive include a flame retardant, an antioxidant, a surfactant, a lithium imide salt, and wax. In a case where the porous layer is easily charged, addition of a surfactant or a lithium imide salt makes it possible to prevent or reduce charging of the porous layer. Examples of the surfactant include nonionic surfactants such as a glycerin fatty acid ester, a polyoxyethylene alkyl ether, and a polyoxyethylene alkylamine, anionic surfactants such as an alkyl sulfonic acid, cationic surfactants such as a tetraalkylammonium salt, and amphoteric surfactants such as an alkylbetaine. Examples of the lithium imide salt include bis(trifluoromethanesulfonyl)imide lithium and bis(pentafluoroethanesulfonyl)imide lithium. Further, addition of the flame retardant and/or a crosslinking agent allows a separator to have higher safety and higher heat resistance.

In order to ensure adhesion of the porous layer to an electrode and a high energy density, the porous layer has a thickness per layer of preferably 0.15 μm to 5 μm, more preferably 0.25 μm to 5 μm, and still more preferably 0.35 μm to 3 μm. The porous layer having a thickness per layer of not less than 0.15 μm (i) makes it possible to sufficiently prevent or reduce an internal short circuit which might occur due to, for example, breakage of the electrochemical device and (ii) allows the porous layer to retain an electrolyte in an adequate amount. Meanwhile, in a case where the porous layer has a thickness per layer of not more than 5 μm, in the electrochemical device, it is possible to minimize metal ion permeability resistance, and thus it is possible to minimize a decrease in rate characteristic and in cycle characteristic. Further, in a case where the porous layer has a thickness per layer of not more than 5 μm, it is also possible to minimize an increase in distance between the positive electrode and the negative electrode. This makes it possible to minimize a reduction in internal volume efficiency of the electrochemical device.

A weight per unit area of the porous layer can be determined as appropriate in view of the strength, thickness, weight, and handleability of the porous layer. The porous layer has a weight per unit area per layer of preferably 0.15 g/m² to 10 g/m², and more preferably 0.25 g/m² to 5 g/m². The porous layer having a weight per unit area in the above numerical range allows the electrochemical device to have a higher weight energy density and a higher volume energy density.

The porous layer has a porosity of preferably 20% by volume to 90% by volume, and more preferably 30% by volume to 80% by volume, in order to achieve sufficient ion permeability. Pores of the porous layer have a diameter of preferably not more than 1.0 μm, and more preferably not more than 0.5 μm. In a case where the pores have such a diameter, the electrochemical device can achieve sufficient ion permeability.

In an embodiment of the present invention, the separator includes a polyolefin porous substrate, and the porous layer is formed on the polyolefin porous substrate. That is, in an embodiment of the present invention, the separator is a separator in which the porous layer and the polyolefin porous substrate are formed on top of each other. In the present specification, such a separator is also referred to as a laminated separator.

The polyolefin porous substrate means a porous substrate that contains a polyolefin-based resin as a main component. The phrase “contain a polyolefin-based resin as a main component” means that the polyolefin-based resin is contained, in the porous substrate, at a proportion of not less than 50% by weight, preferably not less than 90% by weight, and more preferably not less than 95% by weight with respect to all materials that constitute the porous substrate. The porous substrate can be a polyolefin porous film.

The polyolefin-based resin more preferably contains a high molecular weight component having a weight-average molecular weight of 5×10⁵ to 15×10⁶. In particular, the polyolefin-based resin that contains a high molecular weight component having a weight-average molecular weight of not less than 1,000,000 is more preferable because such a polyolefin-based resin allows a resulting separator to have increased strength.

The polyolefin-based resin is exemplified by, but not particularly limited to, thermoplastic resins each obtained by polymerizing a monomer(s) such as ethylene, propylene, 1-butene, 4-methyl-1-pentene, 1-hexene, and/or the like, such as homopolymers and copolymers. Examples of the homopolymers include polyethylene, polypropylene, and polybutene. Examples of the copolymers include an ethylene-propylene copolymer.

Among the above examples of polyolefin-based resins, polyethylene is more preferable because polyethylene makes it possible to prevent a flow of an excessively large electric current to a separator at a lower temperature. Note that preventing the flow of an excessively large electric current is also referred to as “shutdown”. Examples of the polyethylene include low-density polyethylene, high-density polyethylene, linear polyethylene (ethylene-α-olefin copolymer), and ultra-high molecular weight polyethylene having a weight-average molecular weight of not less than 1,000,000. Among these examples, ultra-high molecular weight polyethylene having a weight-average molecular weight of not less than 1,000,000 is still more preferable.

The polyolefin porous substrate may have a multilayer structure including two or more layers. Examples of the polyolefin porous substrate having the multilayer structure include a polyolefin porous substrate in which a layer containing polyethylene as a main component and a layer containing polypropylene as a main component are formed on top of each other. The number of layers formed on top of each other in the polyolefin porous substrate is not particularly limited. The polyolefin porous substrate may include two layers consisting of a layer containing polyethylene as a main component and a layer containing polypropylene as a main component, or may include three layers consisting of a combination of a layer containing polyethylene as a main component and a layer containing polypropylene as a main component. The polyolefin porous substrate having the multilayer structure including a layer containing polyethylene as a main component and a layer containing polypropylene as a main component makes it possible to achieve both a shutdown property and heat resistance.

The polyolefin porous substrate may have a crosslinked structure. The crosslinked structure can be introduced by, for example, using silane-modified polyolefin. The polyolefin porous substrate having the crosslinked structure has excellent heat resistance. Thus, a combination of such a polyolefin porous substrate with a porous layer having heat resistance allows a separator to have higher heat resistance. Note that the crosslinked structure may be provided between the polyolefin porous substrate and the porous layer.

The porous substrate has a thickness of preferably 4 μm to 40 μm, and more preferably 5 μm to 20 μm. The porous substrate having a thickness of not less than 4 μm makes it possible to sufficiently prevent an internal short circuit in the electrochemical device. Meanwhile, the porous substrate having a thickness of not more than 40 μm makes it possible to prevent an increase in size of the electrochemical device.

A weight per unit area of the porous substrate can be determined as appropriate in view of the strength, thickness, weight, and handleability of the porous substrate. Note, however, that the weight per unit area is preferably 4 g/m² to 20 g/m², more preferably 4 g/m² to 12 g/m², and still more preferably 5 g/m² to 10 g/m², so as to allow the electrochemical device to have a higher weight energy density and a higher volume energy density.

The porous substrate has therein many pores connected to one another. This allows a gas and a liquid to pass through the porous substrate from one side to the other side. The porous substrate has an air permeability of preferably 30 s/100 mL to 500 s/100 mL, and more preferably 50 s/100 mL to 300 s/100 mL. The porous substrate having the above air permeability can have sufficient ion permeability. The air permeability represents a value as measured in conformity with JIS P8117 with use of an Oken-type air permeability tester.

The porous substrate has a porosity of preferably 20% by volume to 80% by volume, and more preferably 30% by volume to 75% by volume, so as to (i) retain a larger amount of an electrolyte and (ii) obtain the function of reliably preventing a flow of an excessively large electric current at a lower temperature. In order to achieve sufficient ion permeability and prevent particles from entering the positive electrode and/or the negative electrode, the porous substrate has pores each having a pore diameter of preferably not more than 0.3 μm, and more preferably not more than 0.14 μm.

The separator has a thickness of preferably 3.5 μm to 45 μm, more preferably 3.5 μm to 25 μm, still more preferably 3.5 μm to 20 μm, and particularly preferably 3.5 μm to 18 μm. The separator having a thickness of not less than 3.5 μm makes it possible to sufficiently prevent an internal short circuit in the electrochemical device. Meanwhile, the separator having a thickness of not more than 45 μm makes it possible to prevent an increase in size of the electrochemical device. The thickness of the separator may be 5.5 μm to 45 μm, or may be 6 μm to 25 μm.

The separator has an air permeability of preferably 30 s/100 mL to 1,000 s/100 mL, more preferably 50 s/100 mL to 800 s/100 mL, and still more preferably 70 s/100 mL to 500 s/100 mL. The separator having the above air permeability can achieve sufficient ion permeability in the electrochemical device. The air permeability represents a value as measured in conformity with JIS P8117 with use of an Oken-type air permeability tester.

The separator may be configured to include a porous layer provided on one surface of the above-described porous substrate, or may be configured to include porous layers provided on both surfaces of the porous substrate. Further, a first porous layer and a second porous layer that are provided on both surfaces of the porous substrate may be identical to or different from each other in thickness, weight per unit area, and porosity. Furthermore, the porous layers provided on both surfaces of the porous substrate may have makeups different from each other. The makeups different from each other indicate that front and back porous layers differ in, for example, (i) types of resin and filler which are contained in a porous layer and (ii) filler filling amount. Note that the examples shown in the foregoing description of the porous layer are applicable to the resin and the filler, and the filler filling amount.

The separator may include, as necessary, another functional layer different from the above-described porous substrate and the above-described porous layer (e.g., heat-resistant layer), provided that the object of the present invention is not prevented from being attained. Examples of the another functional layer include known porous layers such as an adhesive layer, a protective layer, a shutdown layer, an antistatic layer, and an easy sliding layer.

The another functional layer can be provided on one surface of the separator or on both surfaces of the separator. In a case where the separator includes the above-described porous layer on both surfaces of the porous substrate, the another functional layer may be provided on the porous layer on both surfaces of the separator, or may be provided on the porous layer on one surface of the separator. In a case where the separator includes the above-described porous layer only on one surface of the porous substrate, the another functional layer may be provided on the porous layer, or may be provided on a surface of the porous substrate on which surface the porous layer is not provided. The another functional layer can be provided on an outermost layer of the separator.

For example, the separator further includes an adhesive layer separately from the above-described porous substrate and the above-described porous layer. In the present specification, the adhesive layer means a porous layer having adhesiveness. The adhesive layer can be provided on a surface of the separator which surface is in contact with the electrode. Examples of a component that is contained in the adhesive layer and that contributes to adhesiveness include an acrylic resin and a PVdF-based resin. Examples of the acrylic resin include acrylic resins listed in paragraphs [0072] to [0088] of Japanese Patent Application Publication Tokukai No. 2024-006988. Examples of the PVdF-based resin include PVdF-based resins listed in paragraphs [0017] to [0022] of Japanese Patent Application Publication Tokukai No. 2017-168419. The acrylic resin and the PVdF-based resin may be used singly or in combination. The adhesive layer may further contain a filler in addition to the component that contributes to adhesiveness. The filler can be a filler similar to that added to the porous layer.

A state in which the adhesive layer is present is not particularly limited. The component that contributes to adhesiveness may be present in particle form, or may be present as a homogeneous coating layer. Alternatively, pattern coating may be used to cause the adhesive layer to be present in dot form or in stripe form. Providing the adhesive layer fixes the separator to an electrode via the adhesive layer, so that an electrode laminated body can be obtained. This makes it possible to improve handleability and heat resistance of the electrode laminated body. Further, causing the adhesive layer to be present in particle form, in dot form, or in stripe form makes it possible to prevent or reduce a decrease in ion permeability of a laminated separator.

For example, the separator further includes a shutdown layer separately from the above-described porous substrate and the above-described porous layer. In the present specification, the shutdown layer means a particle layer having a shutdown property. The shutdown layer can be provided on a surface of the separator which surface is in contact with the electrode. Examples of a component that is contained in the shutdown layer and that contributes to the shutdown property include polyethylene particles.

For example, the separator further includes an antistatic layer separately from the above-described porous substrate and the above-described porous layer. In the present specification, the antistatic layer means a layer having an antistatic property. The antistatic layer can be provided on a surface of the separator which surface is in contact with the electrode. A component that is contained in the antistatic layer and that contributes to the antistatic property can be a component identical to any of the materials listed as examples of the surfactant added to the porous layer.

For example, the separator further includes an easy sliding layer separately from the above-described porous substrate and the above-described porous layer. In the present specification, the easy sliding layer means a layer that imparts slidability to the separator. The easy sliding layer can be provided on a surface of the separator which surface is in contact with the electrode. A component that is contained in the easy sliding layer and that contributes to slidability is an anti-blocking agent, a filler, or the like. Providing surface unevenness allows the separator to not only have improved slidability but also have an improved antistatic property. Note that the porous layer on which the surface unevenness is formed by sandblasting the surface of the porous layer may be used as the easy sliding layer.

As a method that prevents the porous layer from being charged and that is different from the above-described method, a unit or substituent that improves hydrophilicity may be introduced into a structure of the nitrogen-containing aromatic resin contained in the porous layer. Alternatively, uneven distribution of electrically conductive polymers as the resin other than the nitrogen-containing aromatic resin the porous layer on the surface of the porous layer also makes it possible to prevent the porous layer from being charged.

### [2. Method for Producing Separator]

The porous layer can be formed with use of a coating solution obtained by dissolving or dispersing a resin in a solvent. Note that the solvent can be described as being a dispersion medium in which a resin is dispersed. Examples of the resin include the above-listed nitrogen-containing aromatic resins and the above-listed resins other than the nitrogen-containing aromatic resins. Examples of a method for forming the coating solution include a mechanical stirring method, an ultrasonic dispersion method, a high-pressure dispersion method, and a media dispersion method.

The porous layer can be formed by, for example, (i) a method of applying the coating solution directly to a surface of a substrate and then removing the solvent, (ii) a method of applying the coating solution to an appropriate support, subsequently removing the solvent so as to form a porous layer, pressure-bonding the porous layer to the substrate, and peeling the support off, (iii) a method of applying the coating solution to a surface of an appropriate support, pressure-bonding the substrate to that surface, peeling the support off, and then removing the solvent, or (iv) a method of carrying out dip coating by immersing the substrate into the coating solution, and then removing the solvent.

The solvent preferably (i) does not have an adverse effect on the substrate, (ii) allows the resin to be uniformly and stably dissolved in the solvent, and (iii) allows the filler to be uniformly and stably dispersed in the solvent. Examples of the solvent include N-methyl-2-pyrrolidone (NMP), N,N-dimethylacetamide, N,N-dimethylformamide, acetone, and water.

The coating solution may contain a filler. As necessary, the coating solution may contain, as a component(s) other than the resin and the filler, for example, a disperser, a plasticizer, a surfactant, and/or a pH adjuster.

The coating solution can be applied to the substrate by a conventionally known method. Specific examples of such a method include a gravure coater method, a dip coater method, a bar coater method, and a die coater method.

In a case where the coating solution contains an aramid resin, the aramid resin can be deposited by applying moisture to a surface to which the coating solution is applied. The porous layer may be formed in this way. A specific method of applying moisture to the surface to which the coating solution is applied is exemplified by, but not particularly limited to, a method of exposing the surface to a high-humidity atmosphere, a method of spraying water with use of a spray or the like, and a method of blowing water vapor via a nozzle or the like.

In particular, a method for producing a laminated separator can be, for example, a method in which, in a method for producing the above-described porous layer, the above-described porous substrate is used as a substrate to which the coating solution is applied.

A method for producing the porous substrate is not particularly limited. For example, a polyolefin resin composition in sheet form is produced by kneading a polyolefin-based resin together with a pore forming agent such as an inorganic bulking agent or a plasticizer, and optionally with another agent(s) such as an antioxidant, and then extruding the kneaded substances. The pore forming agent is then removed from the polyolefin resin composition in sheet form with use of a suitable solvent. Thereafter, the porous substrate can be produced by stretching the polyolefin-based resin composition from which the pore forming agent has been removed.

The inorganic bulking agent is exemplified by, but not particularly limited to, an inorganic filler, specific examples of which include calcium carbonate. The plasticizer is exemplified by, but not particularly limited to, a low molecular weight hydrocarbon such as liquid paraffin.

The above description discusses a method for forming the porous layer on the porous substrate. Note, however, that the substrate may be an electrode such as a positive electrode (described later) or a negative electrode (described later) instead of the porous substrate. In a case where the substrate is an electrode, a coating solution is applied directly to the electrode. This makes it possible to obtain a laminated body in which the electrode and the porous layer are formed on top of each other. Note that the coating solution can be applied to the electrode by a method similar to a method of applying the coating solution to the porous substrate.

### [3. Material, Electrochemical Device]

A material in accordance with an embodiment of the present invention includes a positive electrode, a separator described above, and a negative electrode, the positive electrode, the separator, and the negative electrode being arranged in this order. An electrochemical device in accordance with an embodiment of the present invention includes a separator described above.

Examples of the electrochemical device include a secondary battery and a capacitor. Examples of the secondary battery include a nonaqueous electrolyte secondary battery such as a lithium ion secondary battery. Examples of the capacitor include an electric double layer capacitor. A nonaqueous electrolyte secondary battery is not particularly limited in shape and can have any shape such as the shape of a thin plate (sheet), a disk, a cylinder, or a prism such as a cuboid.

For example, the material can be formed by arranging the positive electrode, the above-described separator, and the negative electrode in this order. The porous layer can be provided between the porous substrate and at least one of the positive electrode and the negative electrode. The material is then placed in a container that serves as a housing for the electrochemical device. In this manner, it is possible to produce the electrochemical device. In the case of a nonaqueous electrolyte secondary battery, the container is filled with a nonaqueous electrolyte (described later) and then hermetically sealed while pressure is reduced in the container.

### <Positive Electrode>

The positive electrode is not limited to any particular one, provided that the positive electrode is one that is generally used as a positive electrode of an electrochemical device. Examples of the positive electrode include a positive electrode sheet having a structure in which an active material layer containing a positive electrode active material and a binding agent is formed on a positive electrode current collector. The active material layer may further contain an electrically conductive agent.

Examples of the positive electrode active material include materials each capable of being doped with and dedoped of metal ions such as lithium ions or sodium ions. Specific examples of the materials include a lithium-containing complex metal oxide containing lithium (Li) and at least one transition metal selected from the group consisting of V, Cr, Mn, Fe, Co, Ni, Cu, and Al. Examples of such a lithium-containing complex metal oxide include LiCoO₂, LiNiO₂, LiMn₂O₄, Li₂MnO₃, LiNiₓMn_{y}Co_{1-x-y}O₂[0<x+y<1], LiNiₓCo_{y}Al_{1-x-y}O₂[0<x+y<1], LiCr_{0.5}Mn_{0.5}O₂, LiFePO₄, Li₂FeP₂O₇, LiMnPO₄, LiFeBO₃, Li₃V₂(PO₄)₃, Li₂CuO₂, Li₂FeSiO₄, and Li₂MnSiO₄.

Examples of the electrically conductive agent include carbonaceous materials such as natural graphite, artificial graphite, cokes, carbon black (e.g., acetylene black), pyrolytic carbons, fibrous carbon materials, and fired products of and organic polymer compounds. Each of the above electrically conductive agents may be used alone. Alternatively, two or more of the above electrically conductive agents may be used in combination. A proportion of the electrically conductive agent in a positive electrode mix is preferably not less than 5 parts by mass and not more than 20 parts by mass with respect to 100 parts by mass of the positive electrode active material. The proportion can be reduced in a case where a fibrous carbon material such as graphitized carbon fiber or a carbon nanotube is used as the electrically conductive agent.

The binding agent can be a thermoplastic resin. Examples of the thermoplastic resin include fluorine-based resins such as PVdF, polytetrafluoroethylene (PTFE), a tetrafluoroethylene-hexafluoropropylene-vinylidene fluoride-based copolymer, a hexafluoropropylene-vinylidene fluoride-based copolymer, and a tetrafluoroethylene-perfluorovinyl ether-based copolymer, acrylic resins, styrene butadiene rubber, polyimide resins, and polyolefin resins. Note that the binding agent serves also as a thickener. It is possible to use a mixture of two or more of these thermoplastic resins. A positive electrode mix that has both great adhesion to the positive electrode current collector and a high bonding strength inside the positive electrode mix can be obtained by using a fluorine-based resin and a polyolefin resin as a binder to adjust a ratio of the fluorine-based resin to all the positive electrode mix to not less than 1% by mass and not more than 10% by mass, and adjust a ratio of the polyolefin resin to all the positive electrode mix to not less than 0.1% by mass and not more than 2% by mass.

Examples of the positive electrode current collector include electric conductors such as Al, Ni, and stainless steel. Among these electric conductors, Al is more preferable because Al is easily processed into a thin film and is inexpensive.

Examples of a method for producing the positive electrode sheet include: a method in which the positive electrode active material, the electrically conductive agent, and the binding agent (positive electrode mix) are pressure-molded on the positive electrode current collector; and a method in which (i) the positive electrode mix is formed into a paste with use of an appropriate organic solvent, (ii) the positive electrode current collector is coated with the paste, and (iii) the paste is dried and then pressure is applied so that the paste is firmly fixed to the positive electrode current collector.

Examples of an organic solvent that can be used in the above method include: amine-based solvents such as N,N-dimethylaminopropylamine and diethylenetriamine; ether-based solvents such as tetrahydrofuran; ketone-based solvents such as methyl ethyl ketone; ester-based solvents such as methyl acetate; and amide-based solvents such as dimethylacetamide and NMP.

Examples of a method of applying a paste of the positive electrode mix to the positive electrode current collector include a slit-die coating method, a screen coating method, a curtain coating method, a knife coating method, a gravure coating method, and an electrostatic spray method.

### <Negative Electrode>

The negative electrode is not limited to any particular one, provided that the negative electrode is one that is generally used as a negative electrode of an electrochemical device. Examples of the negative electrode include a negative electrode sheet having a structure in which an active material layer containing a negative electrode active material and a binding agent is formed on a negative electrode current collector. The active material layer may further contain an electrically conductive agent.

Examples of the negative electrode active material include materials each capable of being doped with and dedoped of metal ions such as lithium ions or sodium ions. Examples of the materials include materials which are carbonaceous materials, chalcogen compounds (such as oxides and sulfides), nitrides, metals, and alloys and each of which is capable of being doped with and dedoped of lithium ions at electric potentials lower than that of the positive electrode. Examples of the carbonaceous materials include natural graphite, artificial graphite, cokes, carbon black, and pyrolytic carbons.

Examples of the oxides that can be used as the negative electrode active material include: oxides of silicon which are represented by a formula SiOₓ (where x is a positive real number), such as SiO₂ and SiO; oxides of titanium which are represented by a formula TiOₓ (where x is a positive real number), such as TiO₂ and TiO; oxides of vanadium which are represented by a formula VOₓ (where x is a positive real number), such as V₂O₅ and VO₂; oxides of iron which are represented by a formula FeOₓ (where x is a positive real number), such as Fe₃O₄, Fe₂O₃, and FeO; oxides of tin which are represented by a formula SnOₓ (where x is a positive real number), such as SnO₂ and SnO; oxides of tungsten which are represented by a general formula WOₓ (where x is a positive real number), such as WO₃ and WO₂; and complex metal oxides each of which contains lithium and titanium or vanadium, such as Li₄Ti₅O₁₂ and LiVO₂.

Examples of the sulfides that can be used as the negative electrode active material include: sulfides of titanium which are represented by a formula TiSₓ (where x is a positive real number), such as Ti₂S₃, TiS₂, and TiS; sulfides of vanadium which are represented by a formula VSₓ (where x is a positive real number), such as V₃S₄, VS₂, and VS; sulfides of iron which are represented by a formula FeSₓ (where x is a positive real number), such as Fe₃S₄, FeS₂, and FeS; sulfides of molybdenum which are represented by a formula MoSₓ (where x is a positive real number), such as Mo₂S₃ and MoS₂; sulfides of tin which are represented by a formula SnSₓ (where x is a positive real number), such as SnS₂ and SnS; sulfides of tungsten which are represented by a formula WSₓ (where x is a positive real number), such as WS₂; sulfides of antimony which are represented by a formula SbSₓ (where x is a positive real number), such as Sb₂S₃; and sulfides of selenium which are represented by a formula SeSₓ (where x is a positive real number), such as Se₅S₃, SeS₂, and SeS.

Examples of the nitrides that can be used as the negative electrode active material include lithium-containing nitrides such as Li₃N and Li₃₋ₓAₓN (where A is one or both of Ni and Co, and 0<x<3 is satisfied).

Each of these carbonaceous materials, oxides, sulfides, and nitrides may be used alone. Alternatively, two or more of these carbonaceous materials, oxides, sulfides, and nitrides may be used in combination. These carbonaceous materials, oxides, sulfides, and nitrides may be each crystalline or amorphous.

Examples of the metals that can be used as the negative electrode active material include lithium metals, silicon metals, and tin metals.

Examples of the alloys that can be used as the negative electrode active material include lithium alloys such as Li—Al, Li—Ni, Li—Si, Li—Sn, and Li—Sn—Ni; silicon alloys such as Si—Zn; tin alloys such as Sn—Mn, Sn—Co, Sn—Ni, Sn—Cu, and Sn—La; and alloys such as Cu₂Sb and La₃Ni₂Sn₇.

These metals and alloys are each mainly solely used as an electrode after being processed into, for example, foil form. Among the above-listed negative electrode active materials, a carbonaceous material that contains, as a main component, graphite such as natural graphite or artificial graphite is preferably used. This is because such a carbonaceous material hardly changes in electric potential of a negative electrode (has good potential evenness) from an uncharged state to a fully charged state during charging, has a low average discharge potential, and has a high capacity maintenance rate (has a good cycle characteristic) when charging and discharging are repeatedly carried out. The shape of the carbonaceous material may be, for example, any of the following: a flake shape like natural graphite; a spherical shape like mesocarbon microbeads; a fibrous shape like graphitized carbon fiber; an aggregate of fine powders; and the like.

Examples of the negative electrode current collector include Cu, Ni, and stainless steel. Among these materials, Cu is more preferable because Cu is not easily alloyed with lithium and is easily processed into a thin film.

Examples of a method for producing the negative electrode sheet include: a method in which the negative electrode active material is pressure-molded on the negative electrode current collector; and a method in which (i) the negative electrode active material is formed into a paste with use of an appropriate organic solvent, (ii) the negative electrode current collector is coated with the paste, and (iii) the paste is dried and then pressure is applied so that the paste is firmly fixed to the negative electrode current collector. The paste preferably contains any of the above-listed electrically conductive agents and any of the above-listed binding agents.

The negative electrode sheet may contain a binder, as necessary. The binder can be, for example, a thermoplastic resin, specific examples of which include PVdF, thermoplastic polyimides, carboxymethyl cellulose, and polyolefin resins.

### <Nonaqueous Electrolyte>

A nonaqueous electrolyte is not limited to any particular one, provided that the nonaqueous electrolyte is one that is generally used for an electrochemical device, e.g., a nonaqueous electrolyte secondary battery. The nonaqueous electrolyte can be, for example, a nonaqueous electrolyte containing an organic solvent and a lithium salt dissolved in the organic solvent. Examples of the lithium salt include LiClO₄, LiPF₆, LiAsF₆, LiSbF₆, LiBF₄, LiCF₃SO₃, LiN(CF₃SO₂)₂, LiC(CF₃SO₂)₃, LiN(SO₂C₂F₅)₂, LiN(SO₂CF₃)(COCF₃), Li(C₄F₉SO₃), Li₂B₁₀Cl₁₀, LiBOB (where BOB refers to bis(oxalato)borate), LiFSI (where FSI refers to bis(fluorosulfonyl)imide), lower aliphatic carboxylic acid lithium salt, and LiAlCl₄. Each of the above lithium salts may be used alone. Alternatively, two or more of the above lithium salts may be used in combination. Among these electrolytes, it is preferable to use at least one fluorine-containing lithium salt selected from the group consisting of LiPF₆, LiAsF₆, LiSbF₆, LiBF₄, LiCF₃SO₃, LiN(SO₂CF₃)₂, and LiC(SO₂CF₃)₃.

Examples of the organic solvent include: carbonates such as propylene carbonate, ethylene carbonate, dimethyl carbonate, diethyl carbonate, ethyl methyl carbonate, 4-trifluoromethyl-1,3-dioxolane-2-on, and 1,2-di(methoxy carbonyloxy)ethane; ethers such as 1,2-dimethoxyethane, 1,3-dimethoxypropane, pentafluoropropyl methylether, 2,2,3,3-tetrafluoropropyl difluoromethylether, tetrahydrofuran, and 2-methyl tetrahydrofuran; esters such as methyl formate, methyl acetate, and 7-butyrolactone; nitriles such as acetonitrile and butyronitrile; amides such as N,N-dimethylformamide and N,N-dimethylacetamide; carbamates such as 3-methyl-2-oxazolidone; sulfur-containing compounds such as sulfolane, dimethyl sulfoxide, and 1,3-propane sultone; and solvents each prepared by further introducing a fluoro group into any of these organic solvents (i.e., solvents each prepared by substituting one or more hydrogen atoms of any of these organic solvents with one or more respective fluorine atoms). Each of the above organic solvents may be used alone. Alternatively, two or more of the above organic solvents may be used in combination. In particular, a mixed solvent containing a carbonate is preferable, and a mixed solvent containing a cyclic carbonate and an acyclic carbonate, and a mixed solvent containing a cyclic carbonate and an ether are more preferable. The mixed solvent containing a cyclic carbonate and an acyclic carbonate is preferably a mixed solvent containing ethylene carbonate, dimethyl carbonate, and ethyl methyl carbonate. The electrolyte that contains such a mixed solvent has many advantages of having a wide operating temperature range, being less prone to deterioration even when subjected to charging and discharging at a high current rate, being less prone to deterioration even when used for a long period of time, and being less prone to decomposition even when the negative electrode active material is a graphite material such as natural graphite or artificial graphite.

The present invention is not limited to the embodiments, but can be altered by a skilled person in the art within the scope of the claims. The present invention also encompasses, in its technical scope, any embodiment derived by combining technical means disclosed in differing embodiments.

An embodiment of the present invention may include the following features.

<1> A separator for an electrochemical device, including a porous layer that contains two or more nitrogen-containing aromatic resins and that has a filler content of not less than 0% by weight and less than 20% by weight.

<2> The separator described in <1>, wherein the porous layer has a weight per unit area of 0.15 g/m² to 10 g/m².

<3> The separator described in <1> or <2>, wherein the porous layer has a thickness of 0.15 μm to 5 μm.

<4> The separator described in any one of <1> to <3>, wherein the nitrogen-containing aromatic resins include an aramid resin.

<5> The separator described in any one of <1> to <4>, further including a polyolefin porous substrate, the porous layer being formed on the polyolefin porous substrate.

<6> The separator described in <5>, wherein the separator has a thickness of 5.5 μm to 45 μm.

<7> The separator described in <5> or <6>, further including an adhesive layer separately from the polyolefin porous substrate and the porous layer.

<8> A material including a positive electrode, a separator described in any one of <1> to <7>, and a negative electrode, the positive electrode, the separator, and the negative electrode being arranged in this order.

<9> An electrochemical device including a separator described in any one of <1> to <7>.

<10> The electrochemical device described in <9>, wherein the electrochemical device is a secondary battery or a capacitor.

### EXAMPLES

The following description will discuss an example of the present invention.

### <Measurement of Air Permeability of Separator>

A separator was cut into a square piece with a 60 mm side, and the square piece was used as a sample for measuring air permeability of the separator. The sample for measuring air permeability of the separator was placed on a digital Oken-type air permeability tester EGO1 manufactured by ASAHI SEIKO CO., LTD. to measure air permeability of the separator, so that air permeability (unit: s/100 mL) of the separator was obtained.

### <Measurement of Moisture Content of Separator>

A Karl Fischer moisture meter (manufactured by Metrohm Shibata Co., Ltd.) was used to measure a moisture content of the separator on the basis of a Karl Fischer method.

### <Measurement of Gas Yield>

A single-layer laminated cell was produced with use of the following: a separator; a positive electrode formed on an Al current collector (containing lithium metal complex oxide powder, acetylene black, and PVdF); a negative electrode formed on a Cu current collector (containing artificial graphite, styrene butadiene rubber, and carboxymethyl cellulose); and an electrolyte (obtained by dissolving LiPF₆ in a mixed solution of ethylene carbonate, dimethyl carbonate, and ethyl methyl carbonate with a volume ratio of 3:2:5 so as to achieve LiPF₆ concentration of 1.0 mol/L).

A formation process was carried out under a condition that, at a test temperature of 25° C., the laminated cell is charged to 100% of SOC by CC-CV charging at 0.1 CA and discharged to 2.5 V at 0.2 CA. After that, the laminated cell was temporarily opened so as to carry out degassing, and a volume before storage was measured by an Archimedes method. Thereafter, a volume of the laminated cell that was charged to 4.3 V, stored in a thermostatic bath at 60° C. for 7 days, and then discharged to 2.7 V at a current value of 1 CA was measured by the Archimedes method. A gas yield was determined from a difference between the volume after storage at 60° C. for 7 days and the volume before storage.

The Archimedes method is a method of using an automatic densimeter to measure a solid volume of the entire laminated cell from a difference between an aerial weight and an underwater weight of the laminated cell.

### <Measurement of Thickness of Separator>

The thickness of the separator was measured with use of a high-accuracy digital measuring instrument (manufactured by Mitutoyo Corporation). Specifically, each of the separators was cut into a square piece with an 8 cm side, and measurement was carried out at five points in the square piece. The thickness was determined from an average value of measurements obtained at the five points.

### <Charpy Test: Measurement of Swing-Up Angle>

From the separator, 10 strip-shaped samples each measuring 80 mm×10 mm and having a longitudinal direction along an MD direction were cut out. These strip-shaped samples were used to carry out a Charpy test in conformity with JIS K7111-1 (2012). The Charpy test was carried out with use of the following measuring device and under the following measurement conditions.
Device: Universal impact tester (YASUDA SEIKI SEISAKUSHO, LTD., No. 258)
Specimen: 80 mm×10 mm
Lifting angle: 150°
Number of times of measurement: 10 times
Pendulum (hammer) capacity: 1 J
Number of specimen sheets: 1 sheet
Notch in specimen: None
An average value of swing-up angles obtained by carrying measurement 10 times was regarded as a swing-up angle in the MD direction.

Further, except that 10 strip-shaped samples each measuring 80 mm×10 mm and having a longitudinal direction along a TD direction were cut out, the Charpy test was carried out by a method similar to the method in a case where the strip-shaped samples each have the longitudinal direction along the MD direction. An average value of swing-up angles obtained by carrying measurement 10 times was regarded as a swing-up angle in the TD direction.

### Synthesis Example 1: Synthesis of Resin A

A resin A (poly(4,4′-diphenylsulfonyl terephthalamide)) was synthesized by the following procedure.

1. A 0.5-L separable flask having a stirring blade, a thermometer, a nitrogen incurrent canal, and a powder addition port was sufficiently dried.
2. 408.6 g of NMP was introduced into the flask. Further, 31.4 g of calcium chloride (having been dried at 200° C. for 2 hours) was added, and a resulting mixture was heated to 100° C.
3. After the calcium chloride completely dissolved, 31.97 g of 4,4′-diaminodiphenylsulfone was added at 100° C., and then a resulting mixture was completely dissolved.
4. A resulting solution was cooled to room temperature. While the temperature of the solution was maintained at 25±2° C., 25.88 g in total of terephthalic acid dichloride was added in 3 separate portions.
5. While the temperature of a resulting solution was maintained at 25±2° C., the solution was matured for 1 hour to obtain the solution that contained the resin A.

### Synthesis Example 2: Synthesis of Resin B

A resin B (poly(paraphenylene terephthalamide)) was synthesized by the following procedure.

1. A 0.5-L separable flask having a stirring blade, a thermometer, a nitrogen incurrent canal, and a powder addition port was sufficiently dried.
2. 408.6 g of NMP was introduced into the flask. Further, 31.4 g of calcium chloride (having been dried at 200° C. for 2 hours) was added, and a resulting mixture was heated to 100° C.
3. After the calcium chloride completely dissolved, the temperature of a resulting solution was returned to room temperature. Subsequently, 13.20 g of paraphenylenediamine was added and completely dissolved.
4. While the temperature of a resulting solution was maintained at 25±2° C., 24.24 g in total of terephthalic acid dichloride was added in 3 separate portions.
5. While the temperature of a resulting solution was maintained at 25±2° C., the solution was matured for 1 hour to obtain the solution that contained the resin B.

### Synthesis Example 3: Synthesis of Resin C

A resin C (poly(2-chloroparaphenylene terephthalamide)) was synthesized by the following procedure.

1. A 0.5-L separable flask having a stirring blade, a thermometer, a nitrogen incurrent canal, and a powder addition port was sufficiently dried.
2. 441.4 g of NMP was introduced into the flask. Further, 33.9 g of calcium chloride (having been dried at 200° C. for 2 hours) was added, and a resulting mixture was heated to 100° C.
3. After the calcium chloride completely dissolved, the temperature of a resulting solution was returned to room temperature. Subsequently, 5.18 g of 2-chloro-1,4-phenylenediamine was added and completely dissolved.
4. While the temperature of a resulting solution was maintained at 25±2° C., 7.13 g in total of terephthalic acid dichloride was added in 3 separate portions.
5. While the temperature of a resulting solution was maintained at 25±2° C., the solution was matured for 1 hour to obtain the solution that contained the resin C.

### Synthesis Example 4: Dissolution of Resin D

A solution containing a resin D (poly[N,N′-(1,3-phenylene) isophthalamide]) was obtained by the following procedure.

1. A 0.5-L separable flask having a stirring blade, a thermometer, a nitrogen incurrent canal, and a powder addition port was sufficiently dried.
2. 408.6 g of NMP was introduced into the flask. Further, 31.4 g of calcium chloride (having been dried at 200° C. for 2 hours) was added, and a resulting mixture was heated to 100° C.
3. After the calcium chloride completely dissolved, 28.09 g of poly[N,N′-(1,3-phenylene) isophthalamide](manufactured by Sigma-Aldrich Co. LLC) was added, stirred at 125° C., and completely dissolved.
4. A resulting solution was cooled to room temperature to obtain the solution that contained the resin D.

### Example 1

A porous layer that contained the resin A and the resin B at a weight ratio of 90:10 was produced. Specifically, the solutions obtained in Synthesis Examples 1 and 2 were mixed so that the weight ratio between the resin A and the resin B was 90:10. To 500 g of a resulting mixture (1), 17.27 g of calcium carbonate was added. A resulting solution was stirred for 10 minutes so as to be neutralized. Thus, a neutralized solution (1) was obtained. Subsequently, the neutralized solution (1) was diluted with NMP and defoamed under reduced pressure to prepare a coating solution (1) in slurry form. The coating solution (1) had a solid content concentration of 4.5% by weight.

The coating solution (1) was applied to a polyethylene porous film (thickness: 10.3 μm, air permeability: 180 s/100 mL), and the polyethylene porous film to which the coating solution (1) was applied was treated in an oven at 50° C. and a humidity of 70% for 1 minute so that a porous layer (1) was deposited. Thereafter, the resulting polyethylene porous film was washed with water and dried to obtain a separator including the porous layer (1). The porous layer (1) had a weight per unit area of 1.7 g/m².

### Example 2

Operations were carried out in the same manner as in Example 1 to obtain a separator including a porous layer (2), except that the solutions obtained in Synthesis Examples 1 and 2 were mixed so that the weight ratio between the resin A and the resin B was 70:30. The porous layer (2) had a weight per unit area of 1.4 g/m².

### Example 3

Operations were carried out in the same manner as in Example 1 to obtain a separator including a porous layer (3), except that the solutions obtained in Synthesis Examples 1 and 2 were mixed so that the weight ratio between the resin A and the resin B was 50:50. The porous layer (3) had a weight per unit area of 1.2 g/m².

### Example 4

Operations were carried out in the same manner as in Example 1 to obtain a separator including a porous layer (4), except (i) that the solutions obtained in Synthesis Examples 1 and 2 were mixed so that the weight ratio between the resin A and the resin B was 40:60 and (ii) that the thickness of the polyethylene porous film was changed to 8.9 μm. The porous layer (4) had a weight per unit area of 1.6 g/m².

### Example 5

Operations were carried out in the same manner as in Example 1 to obtain a separator including a porous layer (5), except (i) that the solutions obtained in Synthesis Examples 1 and 2 were mixed so that the weight ratio between the resin A and the resin B was 30:70 and (ii) that the thickness of the polyethylene porous film was changed to 8.3 μm. The porous layer (5) had a weight per unit area of 1.4 g/m².

### Example 6

Operations were carried out in the same manner as in Example 1 to obtain a separator including a porous layer (6), except (i) that the solutions obtained in Synthesis Examples 1 and 2 were mixed so that the weight ratio between the resin A and the resin B was 10:90 and (ii) that the thickness of the polyethylene porous film was changed to 8.3 μm. The porous layer (6) had a weight per unit area of 1.0 g/m².

### Example 7

Operations were carried out in the same manner as in Example 3 to obtain a separator including a porous layer (7), except that alumina (average particle diameter: 13 nm) was added so that a weight ratio among the resin A, the resin B, and the alumina was 50:50:1. An alumina content in the porous layer (7) was approximately 1.0% by weight. The porous layer (7) had a weight per unit area of 1.7 g/m².

### Example 8

Operations were carried out in the same manner as in Example 7 to obtain a separator including a porous layer (8), except that alumina was added so that the weight ratio among the resin A, the resin B, and the alumina was 50:50:5. An alumina content in the porous layer (8) was approximately 4.8% by weight. The porous layer (8) had a weight per unit area of 2.1 g/m².

### Example 9

Operations were carried out in the same manner as in Example 7 to obtain a separator including a porous layer (9), except that alumina was added so that the weight ratio among the resin A, the resin B, and the alumina was 50:50:20. An alumina content in the porous layer (9) was approximately 16.7% by weight. The porous layer (9) had a weight per unit area of 1.0 g/m².

### Example 10

Operations were carried out in the same manner as in Example 1 to obtain a separator including a porous layer (10), except that the solutions obtained in Synthesis Examples 2 and 3 were mixed so that a weight ratio between the resin B and the resin C was 50:50. The porous layer (10) had a weight per unit area of 1.6 g/m².

### Example 11

Operations were carried out in the same manner as in Example 10 to obtain a separator including a porous layer (11), except that alumina was added so that a weight ratio among the resin B, the resin C, and the alumina was 50:50:20. An alumina content in the porous layer (11) was approximately 16.7% by weight. The porous layer (11) had a weight per unit area of 1.7 g/m².

### Example 12

Operations were carried out in the same manner as in Example 1 to obtain a separator including a porous layer (12), except that the solutions obtained in Synthesis Examples 1 and 4 were mixed so that a weight ratio between the resin A and the resin D was 50:50. The porous layer (12) had a weight per unit area of 0.9 g/m².

### Example 13

Operations were carried out in the same manner as in Example 1 to obtain a separator including a porous layer (13), except that the solutions obtained in Synthesis Examples 2 and 4 were mixed so that a weight ratio between the resin B and the resin D was 50:50. The porous layer (13) had a weight per unit area of 1.9 g/m².

### Example 14

Operations were carried out in the same manner as in Example 1 to obtain a separator including a porous layer (14), except that the solutions obtained in Synthesis Examples 1, 2, and 4 were mixed so that a weight ratio among the resin A, the resin B, and the resin D was 34:33:33. The porous layer (14) had a weight per unit area of 1.1 g/m².

### Example 15

Operations were carried out in the same manner as in Example 1 to obtain a separator including a porous layer (15) on both surfaces thereof, except (i) that the solutions obtained in Synthesis Examples 1 and 2 were mixed so that the weight ratio between the resin A and the resin B was 40:60, (ii) that the thickness of the polyethylene porous film was changed to 5.2 μm, and that (iii) both surfaces of the separator were coated with the porous layer. The porous layer (15) on both surfaces of the separator had a weight per unit area of 0.8 g/m² in total.

### Comparative Example 1

Operations were carried out in the same manner as in Example 1 to obtain a separator, except that the solution obtained in Synthesis Example 1 was used so that the weight ratio between the resin A and the resin B was 100:0.

### Comparative Example 2

Operations were carried out in the same manner as in Example 1 to obtain a separator, except that the solution obtained in Synthesis Example 2 was used so that the weight ratio between the resin A and the resin B was 0:100.

### Comparative Example 3

Operations were carried out in the same manner as in Example 10 to obtain a separator, except that the solution obtained in Synthesis Example 3 was used so that the weight ratio between the resin B and the resin C was 0:100.

### Comparative Example 4

Operations were carried out in the same manner as in Example 12 to try to produce a separator, except that the solution obtained in Synthesis Example 4 was used so that the weight ratio between the resin A and the resin D was 0:100. However, due to poor deposition, it was impossible to obtain a separator.

### Comparative Example 5

Operations were carried out in the same manner as in Comparative Example 2 to obtain a separator including a porous layer (C5), except that alumina (average particle diameter: 13 nm) was added so that a weight ratio between the resin B and the alumina was 100:100. An alumina content in the porous layer (C5) was 50% by weight. The porous layer (C5) had a weight per unit area of 1.7 g/m².

### Comparative Example 6

Operations were carried out in the same manner as in Example 7 to obtain a separator including a porous layer (C6), except that alumina was added so that the weight ratio among the resin A, the resin B, and the alumina was 50:50:100. An alumina content in the porous layer (C6) was 50% by weight. The porous layer (C6) had a weight per unit area of 1.6 g/m².

### Results

Tables 1 to 3 1 show makeups and evaluation results of Examples and Comparative Examples.

TABLE 1

| | | | | | Resin 1:Resin | | Filler content | | | |
|---|---|---|---|---|---|---|---|---|---|---|
| | | | | One | 2:Resin 3 | Filler:Resin | in porous | | Air | Moisture |
| | Resin | Resin | Resin | surface/Both | (weight | (weight | layer (% by | Thickness | permeability | content |
| | 1 | 2 | 3 | surfaces | ratio) | ratio) | weight) | (μm) | (s/100 mL) | (ppm) |
| Example 1 | Resin | Resin | — | One surface | 90:10:0 | 0:100 | 0 | 13.0 | 224 | 550 |
| | A | B | | | | | | | | |
| Example 2 | Resin | Resin | — | One surface | 70:30:0 | 0:100 | 0 | 12.4 | 371 | 870 |
| | A | B | | | | | | | | |
| Example 3 | Resin | Resin | — | One surface | 50:50:0 | 0:100 | 0 | 12.8 | 417 | 790 |
| | A | B | | | | | | | | |
| Example 4 | Resin | Resin | — | One surface | 40:60:0 | 0:100 | 0 | 11.7 | 209 | 1,000 |
| | A | B | | | | | | | | |
| Example 5 | Resin | Resin | — | One surface | 30:70:0 | 0:100 | 0 | 10.5 | 231 | 1,070 |
| | A | B | | | | | | | | |
| Example 6 | Resin | Resin | — | One surface | 10:90:0 | 0:100 | 0 | 9.2 | 423 | 810 |
| | A | B | | | | | | | | |
| Example 7 | Resin | Resin | — | One surface | 50:50:0 | 1:100 | Approximately 1.0 | 13.2 | 249 | 540 |
| | A | B | | | | | | | | |
| Example 8 | Resin | Resin | — | One surface | 50:50:0 | 5:100 | Approximately 4.8 | 13.8 | 264 | 720 |
| | A | B | | | | | | | | |
| Example 9 | Resin | Resin | — | One surface | 50:50:0 | 20:100 | Approximately 16.7 | 14.3 | 223 | 860 |
| | A | B | | | | | | | | |
| Example 10 | Resin | Resin | — | One surface | 50:50:0 | 0:100 | 0 | 12.5 | 1,031 | 520 |
| | B | C | | | | | | | | |
| Example 11 | Resin | Resin | — | One surface | 50:50:0 | 20:100 | Approximately 16.7 | 12.1 | 738 | 630 |
| | B | C | | | | | | | | |
| Example 12 | Resin | Resin | — | One surface | 50:50:0 | 0:100 | 0 | 14.0 | 199 | 750 |
| | A | D | | | | | | | | |
| Example 13 | Resin | Resin | — | One surface | 50:50:0 | 0:100 | 0 | 14.1 | 262 | 920 |
| | B | D | | | | | | | | |
| Example 14 | Resin | Resin | Resin | One surface | 34:33:33 | 0:100 | 0 | 13.3 | 215 | 750 |
| | A | B | D | | | | | | | |
| Example 15 | Resin | Resin | — | Both | 40:60:0 | 0:100 | 0 | 6.5 | 226 | 950 |
| | A | B | | surfaces | | | | | | |
| Comparative | Resin | — | — | One surface | 100:0:0 | 0:100 | 0 | 13.2 | 9,999 | — |
| Example 1 | A | | | | | | | | | |
| Comparative | Resin | — | — | One surface | 100:0:0 | 0:100 | 0 | 13.1 | 9,999 | — |
| Example 2 | B | | | | | | | | | |
| Comparative | Resin | — | — | One surface | 100:0:0 | 0:100 | 0 | 12.6 | 9,999 | — |
| Example 3 | C | | | | | | | | | |
| Comparative | Resin | — | — | One surface | 100:0:0 | 0:100 | 0 | Poor deposition and failure to | | |
| Example 4 | D | | | | | | | obtain data | | |
| Comparative | Resin | — | — | One surface | 100:0:0 | 100:100 | 50 | 13.3 | 269 | 1,990 |
| Example 5 | B | | | | | | | | | |
| Comparative | Resin | Resin | — | One surface | 50:50:0 | 100:100 | 50 | 13.9 | 228 | 1,640 |
| Example 6 | A | B | | | | | | | | |

Examples and Comparative Examples were all similar in porous layer thickness. In Comparative Examples 1 to 3, in which neither a filler nor two or more resins were mixed, a small amount of moisture was expected to be mixed during production, but air permeability was high. In Comparative Example 4, poor deposition of the porous layer prevented acquisition of data. In Comparative Examples 5 and 6, air permeability was relatively low, but a filler content was more than 20% by weight, and a moisture content was high.

In contrast, in Examples 1 to 15, in which two or more nitrogen-containing aromatic resins were used and a filler content was less than 20% by weight, air permeability was lower than in Comparative Examples 1 to 3, and a moisture content was lower than in Comparative Examples 5 and 6. That is, in Examples 1 to 15, it was possible to achieve both high ion permeability and a low moisture content.

TABLE 2

| | Moisture content | Gas yield |
|---|---|---|
| | (ppm) | (cm³) |
| Example 3 | 790 | 0.03 |
| Example 8 | 720 | 0.04 |
| Comparative | 1,990 | 0.13 |
| Example 5 | | |
| Comparative | 1,640 | 0.09 |
| Example 6 | | |

A gas yield was low in Examples 3 and 8, in which the moisture content was low. In contrast, a gas yield was high in Comparative Examples 5 and 6, in which the moisture content was high.

TABLE 3

| | Swing-up angle in MD | Swing-up angle in TD |
|---|---|---|
| | direction (°) | direction (°) |
| Example 3 | 120 | 113 |
| Comparative | 121 | 119 |
| Example 5 | | |

As shown in Table 3, in Example 3, a swing-up angle measured in the Charpy test was smaller than in Comparative Example 5. In general, a swing-up angle measured in the Charpy test corresponds to energy consumed during destruction of a specimen. The energy being small results in an increase in swing-up angle, whereas the energy being large results in a decrease in swing-up angle. In a separator in accordance with an embodiment of the present invention, large energy is consumed during destruction of a specimen. This is because the separator in accordance with an embodiment of the present invention has a smaller swing-up angle as compared with a conventional separator. That is, it has been proved that the separator in accordance with an embodiment of the present invention has more excellent impact resistance than a conventional separator. In view of the above, a battery in which the separator in accordance with an embodiment of the present invention is mounted is considered to have more excellent safety than a conventional battery.

### INDUSTRIAL APPLICABILITY

An aspect of the present invention is applicable to an electrochemical device.

1. A separator for an electrochemical device, comprising a porous layer that contains two or more nitrogen-containing aromatic resins and that has a filler content of not less than 0% by weight and less than 20% by weight.

2. The separator of claim 1, wherein the porous layer has a weight per unit area of 0.15 g/m² to 10 g/m².

3. The separator of claim 1, wherein the porous layer has a thickness of 0.15 μm to 5 μm.

4. The separator of claim 1, wherein the nitrogen-containing aromatic resins include an aramid resin.

5. The separator of claim 1, further comprising a polyolefin porous substrate,
the porous layer being formed on the polyolefin porous substrate.

6. The separator of claim 5, wherein the separator has a thickness of 5.5 μm to 45 μm.

7. The separator of claim 5, further comprising an adhesive layer separately from the polyolefin porous substrate and the porous layer.

8. A material comprising a positive electrode, a separator recited in claim 1, and a negative electrode, the positive electrode, the separator, and the negative electrode being arranged in this order.

9. An electrochemical device comprising a separator recited in claim 1.

10. The electrochemical device of claim 9, wherein the electrochemical device is a secondary battery or a capacitor.
